(19) United States
(12) Patent Application Publication
(10) Pub. No.: US 2020/0137236 A1
(43) Pub. Date: Apr. 30, 2020

(54) SPECIFIED EQUIPMENT, SYSTEM, AND PROGRAM

(71) Applicant: Shinya MORI, Kanagawa (JP)

(72) Inventor: Shinya MORI, Kanagawa (JP)

(73) Assignee: Ricoh Company, Ltd., Tokyo (JP)

(21) Appl. No.: 16/567,170

(22) Filed: Sep. 11, 2019

(30) Foreign Application Priority Data
Oct. 29, 2018 (JP) 2018-202758

(51) Int. Cl. H04N 1/00; H04N 1/44

(52) U.S. Cl. CPC H04N 1/0097; H04N 1/00244; H04N 2201/0094; H04N 1/4433; H04N 1/00933; H04N 1/00344

(57) ABSTRACT

Specified equipment that communicates with a plurality of apparatuses to transmit execution information for executing a job of a user to an management server on a side of cloud including a circuitry that performs receiving the execution information of the job which is created by the plurality of apparatuses as a result of executing the job by the user who is successfully authenticated in an authentication server, and transmitting the execution information received from the plurality of apparatuses to the management server every predetermined time period.

### CROSS-REFERENCE TO RELATED APPLICATIONS

The present application claims priority under 35 U.S.C. § 119 to Japanese Patent Application No. 2018-202758, filed Oct. 29, 2018. The contents of which are incorporated herein by reference in their entirety.

### BACKGROUND OF THE INVENTION

### 1. Field of the Invention

The present invention relates to specified equipment, a system, and a program.

### 2. Description of the Related Art

There is a form in which an management server administers execution information when a user uses an apparatus such as a multifunction peripheral. The management server administers information about a user as to which and how many jobs the user causes the apparatus to execute. User information related to the user may include a remaining usable amount indicating how the apparatus can be used by each user within a predetermined time period.

In such a case, user authentication is performed to administer the execution information for each user. Here, the authentication server is ordinarily installed on-premise (see, for example, Patent Document 1 (Japanese Laid-Open Patent Application No. 2015-018404). Patent Document 1 discloses a service system having an AD (Active Directory, “Active Directory” is a registered trademark) server installed in an environment of the on-premise, a multifunction peripheral, and an application held in a cloud.

However, if the authentication server is located on the on-premise side and the management server is located on the cloud side, there is an inconvenience that the management server cannot communicate with the authentication server beyond the firewall. Said differently, the management server must communicate with the authentication server, but the management server cannot communicate with the authentication server, in a form in which the management server acts on behalf of the user for authentication instead of the multifunction peripheral. If the management server cannot perform the user authentication, it becomes difficult to administer the execution information of the user.

### SUMMARY OF THE INVENTION

Specified equipment that communicates with a plurality of apparatuses to transmit execution information for executing a job of a user to an management server on a side of cloud including a circuitry that performs receiving the execution information of the job which is created by the plurality of apparatuses as a result of executing the job by the user who is successfully authenticated in an authentication server, and transmitting the execution information received from the plurality of apparatuses to the management server every predetermined time period.

### BRIEF DESCRIPTION OF DRAWINGS

FIG. 1 schematically illustrates an example of a user information administration system.

FIG. 2 schematically illustrates an example of a user information administration system.

FIG. 3 is an exemplary sequence diagram in which a multifunction peripheral requests an authentication server to authenticate in the user information administration system illustrated in FIG. 2 and transmits execution information to the management server.

FIG. 4 illustrates an example of a procedure in which the user information administration system transmits the execution information to the management server.

FIG. 5 schematically illustrates an example of a user information administration system.

FIG. 6 illustrates a hardware configuration of an example of a computer system.

FIG. 7 illustrates a hardware configuration of an example of a multifunction peripheral and specified equipment.

FIG. 8 is an example of a functional block diagram illustrating functions of a multifunction peripheral, an authentication server, specified equipment, and a management server of a user information administration system using blocks.

FIG. 9 is a sequence diagram illustrating an example of a procedure in which specified equipment synchronizes the management server with user information and setup information;

FIG. 10 is an exemplary sequence diagram illustrating authentication and transmission process of the execution information when the user uses the multifunction peripheral.

FIG. 11 is an exemplary sequence diagram illustrating a process of updating setup information of the multifunction peripheral when the setup information is changed.

### DETAILED DESCRIPTION OF THE PREFERRED EMBODIMENTS

According to the related art, the apparatus may communicate with the on-premise authentication server and authenticates the user without going through the management server. In this case, however, there is a problem in that the user's authentication request is sent from each apparatus to the management server on the cloud and the communication load increases.

In view of the above-described problems, one embodiment of the present invention is intended to provide specified equipment that can control information about a user by suppressing an increase in the communication load.

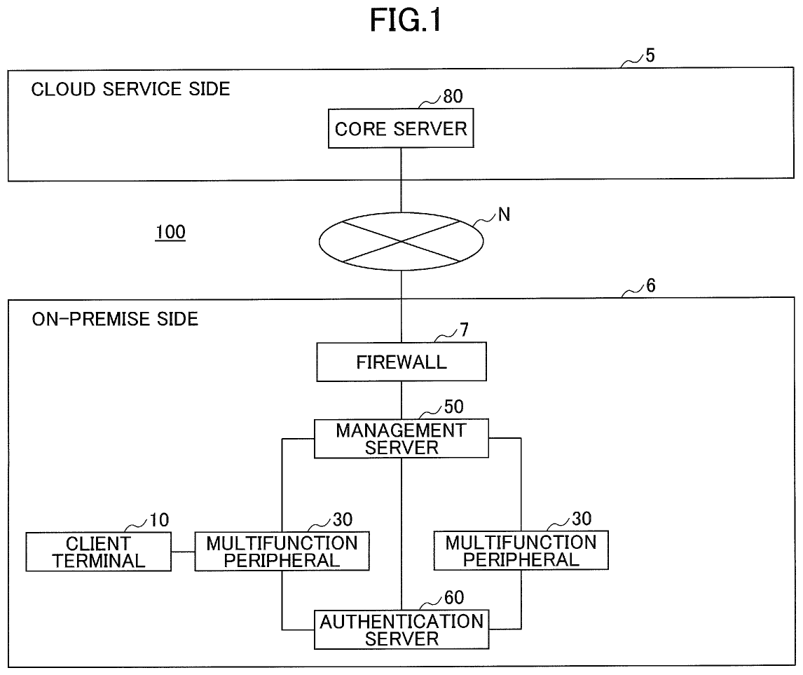

A description is given below, with reference to the FIG. 1 through FIG. 11 of embodiments of the present invention. Where the same reference symbols are attached to the same parts, repeated description of the parts is omitted.

Reference symbols typically designate as follows:
10 Client terminal
30 Multifunction peripheral
50 Administration server
60 Authentication server
70 specified equipment
80 Core server
100 User information administration system

### <Basic Configuration>

In explaining the user information administration system 100 according to the present embodiment, the configuration of FIG. 1 is further described. FIG. 1 schematically illustrates the example of the user information administration system 100. A cloud side 5 has a core server 80, and an on-premise side 6 has a firewall 7, a management server 50, at least one multifunction peripheral 30, a client terminal 10, and an authentication server 60. These details are described later.

The management server 50 is a server that acts as a proxy for the process of the multifunction peripheral 30. The management server 50 administers the user information (including the remaining usable amount based on the execution information) concerning the user, but the details will be described later. The processing of the multifunction peripheral 30 is to reduce the load on the multifunction peripheral 30, such as authentication, scan delivery, and printing as a print server.

In the configuration illustrated in FIG. 1, at the time of authentication by the user, there was a communication flow of the multifunction peripheral 30 to the management server 50 to the authentication server 60.

<Case where Management Server is Placed in Cloud>

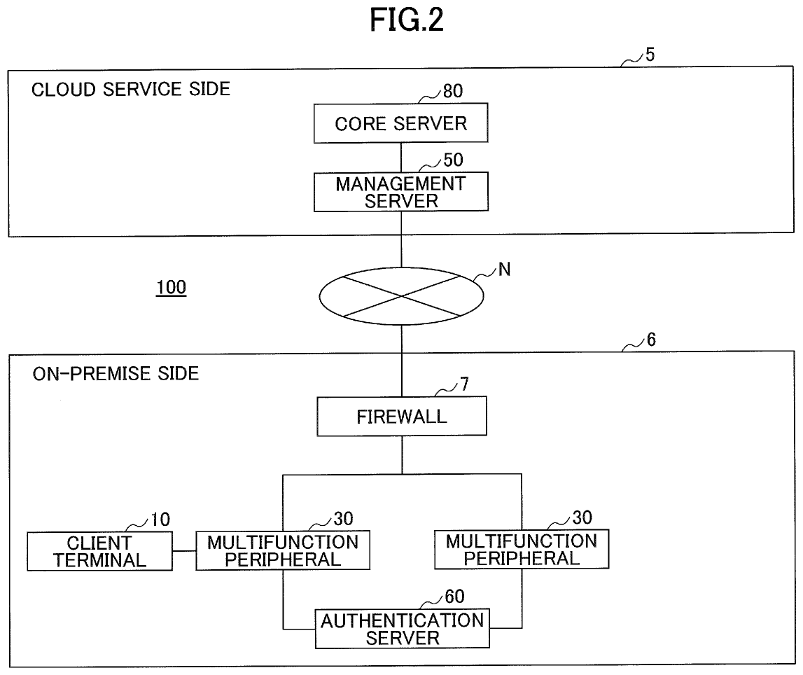

However, some users request that the management server 50 be located on the cloud side 5, and the configuration illustrated in FIG. 2 is considered. Referring to FIG. 2, the management server 50 is located in the cloud. In this case, since it becomes difficult for the management server 50 to communicate with the authentication server 60 beyond the firewall 7, the management server 50 cannot perform authentication in place of the multifunction peripheral 30. Accordingly, in the configuration illustrated in FIG. 2, when authenticating the user, a communication flow of the multifunction peripheral 30 to the authentication server 60 occurs.

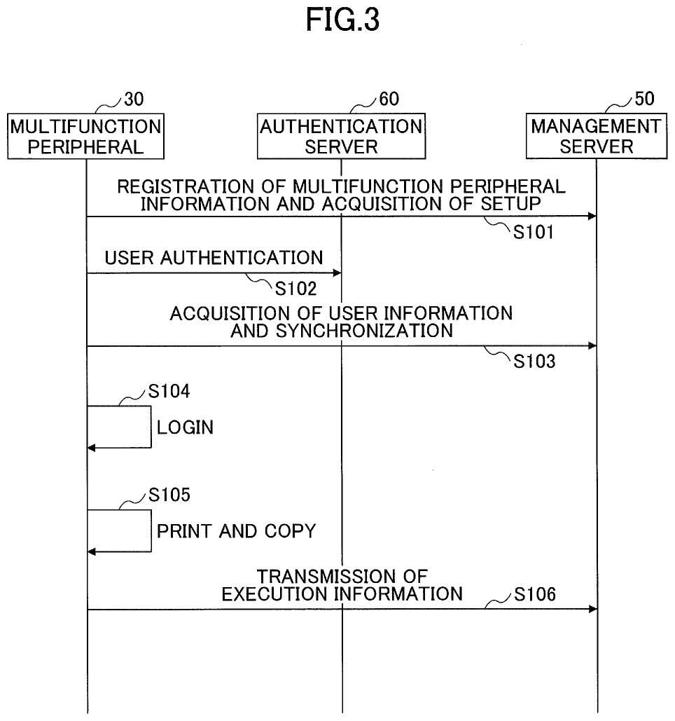

Referring to FIG. 3, this is described in detail.

FIG. 3 is an exemplary sequence diagram in which the multifunction peripheral 30 requests the authentication server 60 to authenticate in the user information administration system 100 illustrated in FIG. 2 and transmits execution information to the management server 50.

S101: The multifunction peripheral 30 communicates with the management server 50 at startup, registers information (such as an IP address) of the own multifunction peripheral and acquires the setup information (such as the IP address of the authentication server 60 to which it is connected). The IP address of the management server 50 is set to the multifunction peripheral 30.

S102: When the user uses the multifunction peripheral 30, the user inputs the user ID and password into the multifunction peripheral 30, so that the multifunction peripheral 30 requests the authentication server 60 to authenticate the user. The authentication server 60 performs user authentication.

S103: When information indicating that authentication is successful is obtained from the authentication server 60, the multifunction peripheral 30 communicates with the management server 50 and acquires the user information (the remaining usable amount for the user, the function usage limiting information, the attribute information such as the user ID or the mail address, etc.).

S104: Successful authentication allows the user to log into the multifunction peripheral 30.

S105: The user can execute print/copy etc. within the range of the remaining usable amount and the function use limitation.

S106: The multifunction peripheral 30 transmits the execution information to the management server 50. Accordingly, in the configuration of FIG. 2, even when the management server 50 is located in the cloud, the user authentication can be performed and the user information can be administered by the management server 50.

However, when a large number of multifunction peripherals 30 are installed in one office, because each of the multifunction peripherals 30 communicates with the management server 50 in steps S101, S103, and S106, the communication load of the management server 50 and the network possibly increase.

### <Outline of Operation of User Information Administration System>

Accordingly, according to the present embodiment, the administrator or the like disposes the predetermined multifunction peripheral 30 as the specified equipment 70 on-premise, and the specified equipment 70 communicates with the management server 50 on behalf of each of the multifunction peripherals 30.

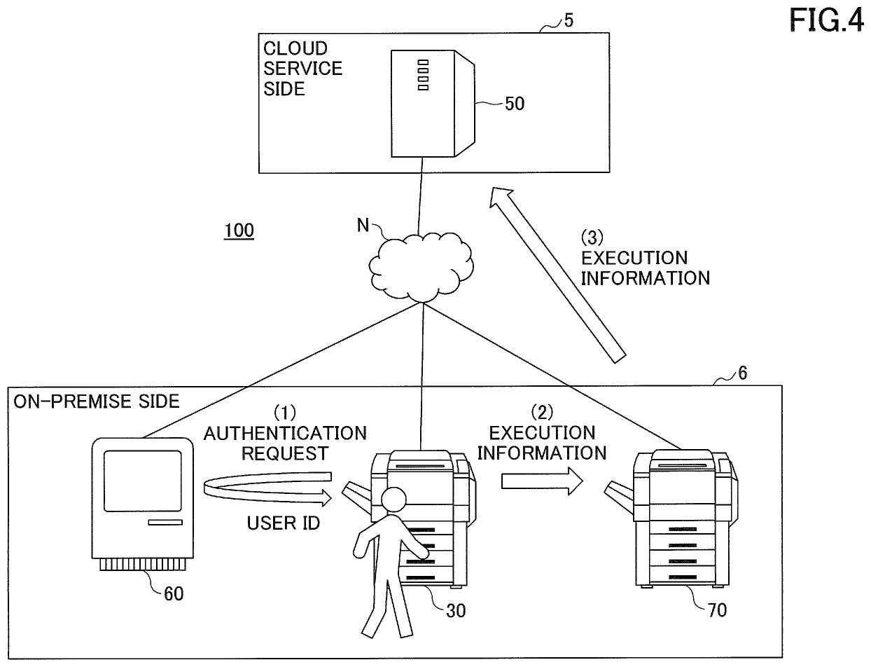

An outline of the operation of the user information administration system 100 will be described with reference to FIG. 4. FIG. 4 is an example of a procedure in which the user information administration system 100 according to the present embodiment transmits the execution information to the management server.

As illustrated in FIG. 4, an management server 50 is disposed on the cloud side 5, and an authentication server 60, a multifunction peripheral 30, and specified equipment 70 are disposed on the on-premise side 6. In such a configuration, the user uses the multifunction peripheral 30.

(1) The multifunction peripheral 30 requests the authentication server 60 for user authentication in order for the user to perform an authentication operation such as holding an IC card. If the authentication is successful, the user is identified and the user ID can be obtained. The same shall apply to a case where the user executes the job from the PC (Personal Computer) rather than directly operating the multifunction peripheral 30 to execute the job.

(2) When the user operates the multifunction peripheral 30 to execute the job, the multifunction peripheral 30 transmits the execution information to the specified equipment 70.

(3) When the specified equipment 70 stores more than a certain amount of execution information or more than a certain time period, it collectively transmits them to the management server 50 of the cloud side 5.

According to such a configuration, the management server 50 is on the cloud side and the authentication server 60 is on the on-premise side. However, since the multifunction peripheral 30 communicates with the authentication server 60, user authentication is possible.

In addition, since the specified equipment 70 transmits the execution information transmitted from at least one multifunction peripheral 30 to the management server 50, the communication load of the management server 50 and the network can be reduced compared to the case where each multifunction peripheral 30 communicates with the management server 50 individually.

### <Terminology>

The apparatus may have functions to execute jobs that the user wants to perform. In the present embodiment, the multifunction peripheral 30 will be described as an example. The apparatus may be, for example, a projector for projecting images, an electronic blackboard for displaying handwritten information, or the like.

The job is a type of work that has data to be processed and the contents of process. The job includes a print job, a copy job, a scan job, etc.

The job execution information is information indicating the job content.

For example, it includes information on how much of a function, such as printing, is performed.
The amount executed is measured in an appropriate execution unit. In case of the multifunction peripheral, the number of pages is often a unit of the amount executed. In addition, the time used, consumption of consumables such as toner, and the like may be used for measurement.

The user information administration system 100 is an example of a system recited in the claims.

### <Example of System Configuration>

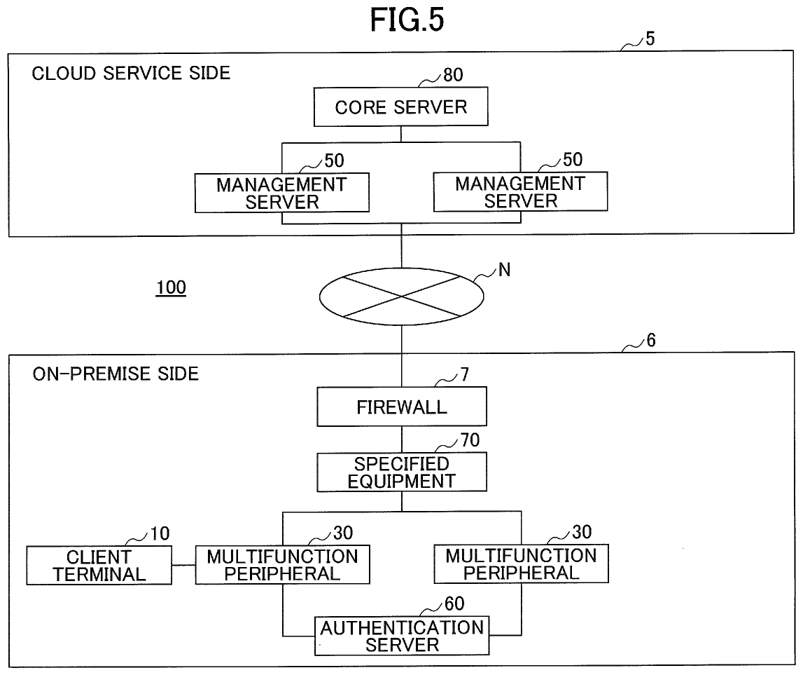

An example of a system configuration will be described with reference to FIG. 5. FIG. 5 schematically illustrates an example of the user information administration system 100. As described above, a core server 80 and one or more management servers 50 are disposed on the cloud side 5, and a firewall 7, the specified equipment 70, the at least one multifunction peripheral 30, the client terminal 10, and the authentication server 60 are disposed in the on-premise side 6.

The core server 80 is a server apparatus (an information processing apparatus, a computer) that collectively administers the information of each multifunction peripheral 30. The core server 80 communicates with the management server 50 and synchronizes the user information with the management server 50. The core server 80 stores the setup information of each multifunction peripheral, and the management server 50 synchronizes the setup information with the core server 80.

The administrator can also reflect the setup information of each multifunction peripheral 30 to the management server 50 by setting the setup information to the core server 80. As will be described later, the user information and the setup information are synchronized between the management server 50 and the specified equipment 70. The specified equipment 70 according to the present embodiment communicates with the management server 50. The specified equipment 70 according to the present embodiment may not communicate with the core server 80 and may communicate with the core server 80, where either case is not described in the present embodiment.

The management server 50 is a server apparatus (an information processing apparatus or a computer) that administers the user information concerning the user who is ultimately synchronized with the core server 80 and performs the process in place of the image forming apparatus by proxy. The management server 50 is conventionally in association with the authentication server 60. The management server 50 administers information administered by the authentication server 60, and information on the remaining usable amount, the function usage limiting information, and the like that cannot be administered by the authentication server 60. Substituting processes include, for example, authentication, scan delivery, processing on the print server, and the like.

Referring to FIG. 5, there is a plurality of management servers 50. However, it is sufficient to have one or more management servers 50. The plurality is to distribute loads.

The firewall 7, the specified equipment 70, the client terminal 10, the one or more multifunction peripherals 30, and the authentication server 60 are coupled to the on-premise side 6 in a communicable manner through a network (one or more LANs constructed through a router or hub).

The firewall 7 is an apparatus or function that is provided in a location where one or more information processing apparatuses are used as an entity and the network is a nodal point, and prevents “communication that should not be passed” from the viewpoint of computer security. Generally, it blocks the communication from the outside to the inside and allows the communication from the inside to the outside. The communication from the outside to the inside is permitted in response to the communication from the inside to the outside.

Specifically, this is determined based on the IP addresses of the destination and source, the direction of the transmission and reception, the protocol type, and the port number. However, the mechanism of the firewall 7 may be whatever.

The specified equipment 70 is an information processing apparatus which synchronizes with the management server 50 by acquiring the user information from the management server 50 and further transmits the execution information to the management server 50. The details of the user information are described below, but it includes the remaining usable amount for the user, the function usage limiting information, and attribute information such as the user ID.

The specified equipment 70 is also coupled to each of the multifunction peripherals 30 for communication. The multifunction peripheral 30 is a MFP in which the specified equipment 70 is in charge of transmitting the execution information.

The specified equipment 70 receives the registration of the information of the multifunction peripheral 30 from the multifunction peripheral 30. This allows the specified equipment 70 to communicate with the multifunction peripheral 30. The setup information such as the IP address of the authentication server 60 is transmitted to the multifunction peripheral 30. The specified equipment 70 is synchronized with the multifunction peripheral 30 by transmitting user information to the multifunction peripheral 30. The execution information is received from each multifunction peripheral 30.

The specified equipment 70 may be an ordinary PC if it has a communication function. On the other hand, the multifunction peripheral 30 may also be used as the specified equipment 70. For example, the multifunction peripheral 30 having high CPU performance and high RAM capacity is selected. The combined use of the multifunction peripheral 30 also as the specified equipment 70 eliminates the need for stand-alone specified equipment 70 and reduces the cost.

As a method of determining the specified equipment 70, the specified equipment 70 that administers the plurality of multifunction peripherals 30 may be disposed at the time of system installation, or a predetermined one from the plurality of multifunction peripherals 30 may be selected as the specified equipment 70. As an example, the parent apparatus in a dependency relationship between the parent and child apparatuses, may be used as the specified equipment 70.

A program that implements the function as the specified equipment 70 is installed in the multifunction peripheral 30 that is designated as the specified equipment 70 by an administrator or the like. The specified equipment 70 is set to have information necessary for communication such as the IP address and the port number of the management server 50.

The multifunction peripheral 30 is an example of the apparatus used by the user. The user operates the multifunction peripheral 30 to execute the job, or sends the job from the client terminal 10 to the multifunction peripheral 30 to execute the job. Execution information is created by executing the job. The multifunction peripheral 30 is configured by an administrator to have an IP address and a port number of the specified equipment 70 so that the multifunction peripheral 30 can communicate with the specified equipment 70.

The multifunction peripheral 30 refers to a apparatus having a plurality of functions, such as a scanner function, a printing function, a copy function, and a fax transmission/reception function. The multifunction peripheral 30 may be called MFP (Multi-Function Printer/Product/Peripheral), SPC (Scan Print Copy), or AIO (All In One).

According to the present embodiment, the multifunction peripheral 30 is not required to have multiple functions. The multifunction peripheral 30 is sufficient to have a function of printing an image on a sheet material such as paper. The multifunction peripheral 30 may also be called an image forming apparatus, a printer (printing apparatus), a scanner apparatus, a copy apparatus, a fax apparatus, or the like.

Further, the multifunction peripheral 30 may be an apparatus of executing a job to generate execution information. For example, a video conference terminal, an electronic blackboard, or a projector. Alternatively, the apparatus may be a medical apparatus, a game machine, a navigation apparatus, or the like.

The client terminal 10 is a terminal apparatus for requesting the multifunction peripheral 30 to execute a job. For example, the client terminal may be a PC, tablet apparatus, smartphone, PDA (Personal Digital Assistant), wearable PC, or the like. Further, when the user directly operates the multifunction peripheral 30, the client terminal 10 may not be present.

The authentication server 60 is one or more information processing apparatuses that authenticate the user. The authentication means that the user of the multifunction peripheral 30 confirms the identity of the person. The information used for authentication is called authentication information (the authentication information in Table 2 below also contains attribute information). The authentication information is a combination of information that identifies the user and information that confirms the identification.

For example, the password, IC card number, or biometric information may be used to verify the information to be identified. Successful authentication allows the user to log into the multifunction peripheral 30. A login is an operation to identify the identity and validity of a user and obtain the credentials necessary for accessing various resources when a computer starts to be used. Resources that can be accessed may be limited depending on the user's privileges. The login may be called log-on, sign-in, or sign-on.

Authentication results refer to the fact that the user has confirmed the identity (successful authentication) or that the user cannot confirm the identity (failed authentication). The authentication server 60 includes a part of the user information according to the present embodiment (user ID, user display name, mail address, fax number, department, cost center, user group, etc.), and the specified equipment 70 can transmit this information to the management server 50.

Although AD (Active Directory: registered trademark) is known as the authentication server 60, the authentication server 60 may have any mechanism.

### <Hardware Configuration><<Example of Hardware Configuration of Management Server, Authentication Server, Client Terminal, and Core Server>>

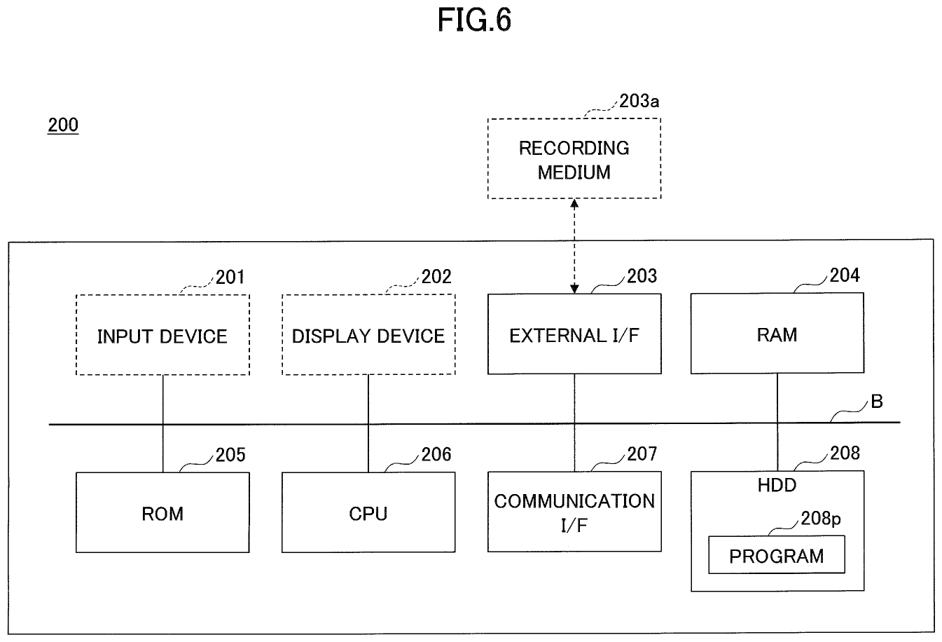

The management server 50 is implemented, for example, by a computer system having a hardware configuration illustrated in FIG. 6. FIG. 6 illustrates a hardware configuration of an example of the computer system 200 according to the present embodiment.

The computer system 200 illustrated in FIG. 6 includes an input device 201, a display device 202, an external I/F 203, a RAM (Random Access Memory) 204, a ROM (Read Only Memory) 205, a CPU (Central Processing Unit) 206, a communication I/F 207, and an HDD (Hard Disk Drive) 208, each of which is coupled to each other by a bus B.

The input device 201 includes a keyboard, a mouse, a touch panel, and the like, and is used by a user to input respective operation signals. Display 202 includes a display or the like to display processing results by the computer system 200. The input device 201 and the display device 202 may be connected as needed and need not be connected at all times.

The communication I/F 207 is an interface that connects the computer system 200 to an internal network, the Internet, or the like. This allows the computer system 200 to perform data communication through communication I/F 207.

The HDD 208 is a non-volatile storage apparatus that stores programs and data. Examples of stored programs and data include the operating system (OS), which is the basic software for controlling the entire computer system 200, and application software that provides various functions on the OS. Programs and data stored in the HDD 208. It is administered by the prescribed file system and/or DB (database).

An external I/F 203 is an interface with an external device. An external device includes a recording medium 203a or the like. This allows the computer system 200 to read and/or write the recording medium 203a through the external I/F 203. The recording medium 203a includes a flexible disk, a CD (Compact Disk), a DVD (Digital Versatile Disk), an SD Memory Card (SD Memory Card), and a Universal Serial Bus memory (USB Memory).

The ROM 205 is a non-volatile semiconductor memory (memory device) that can hold programs and data even when the power is turned off. The ROM 205 stores programs and data such as the BIOS (Basic Input/Output System), OS setting, and network setting that are executed when the computer system 200 is started. RAM 204 is a volatile semiconductor memory (memory device) that temporarily holds programs and data.

The CPU 206 is an arithmetic apparatus which substantializes the control and functions of the entire computer system 200 by reading out programs and data from memory devices such as the ROM 205 and the HDD 208 to the RAM 204 and executing the processing.

The management server 50 may support cloud computing. The cloud computing is a form of use in which resources on a network are used without being conscious of specific hardware resources.

Even though the hardware configuration of the client terminal 10, the authentication server 60, or the core server 80 is similar to or different from that of FIG. 6, it is not hindered for the explanation of the present embodiment.

### <MFPs and Specified Equipment>

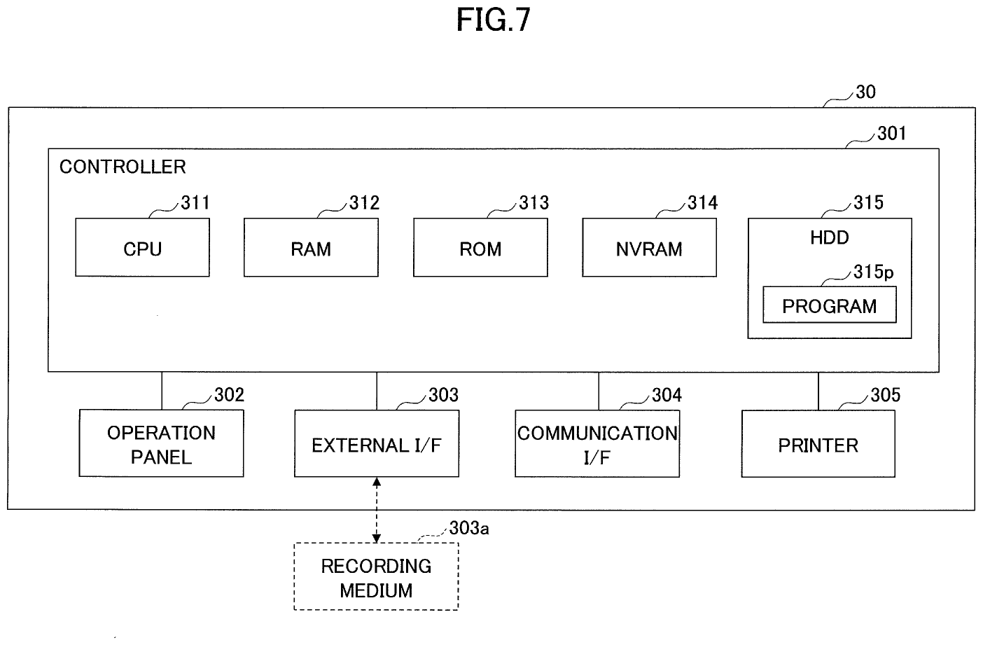

The multifunction peripheral 30 and the specified equipment 70 according to the present embodiment are implemented in a hardware configuration, for example, illustrated in FIG. 7. FIG. 7 illustrates a hardware configuration of an example of the multifunction peripheral 30 and specified equipment 70 according to the present embodiment. The multifunction peripheral 30 illustrated in FIG. 7 includes a controller 301, an operation panel 302, an external I/F 303, a communication I/F 304, and a printer 305.

The controller 301 includes CPU 311, RAM 312, ROM 313, NVRAM 314, and HDD 315. The ROM 313 stores various programs and data. RAM 312 temporarily holds programs and data. The NVRAM 314 stores, for example, setup information. The HDD 315 stores various programs 315p and data.

The CPU 311 substantializes the control and function of the entire multifunction peripheral 30 by reading the program 315p, the data, the setup information, etc. from the ROM 313, the NVRAM 314, the HDD 315, or the like onto the RAM 312 and executing the processes.

The operation panel 302 includes an input unit for receiving an input from the user and a display unit for displaying. The external I/F 303 is an interface with an external device. The external device includes a recording medium 303a or the like. Thus, the multifunction peripheral 30 can read and/or write data from and/or to the recording medium 203a through the external I/F 303. The recording medium 303a includes a flexible disk, a CD, a DVD, an SD memory card, a USB memory, or the like.

The communication I/F 304 is an interface for conducting communication through network N. Thus, the multifunction peripheral 30 can perform data communication through the communication I/F 304. The printer 305 is a printing apparatus for printing and outputting the data to be printed.

### <Function>

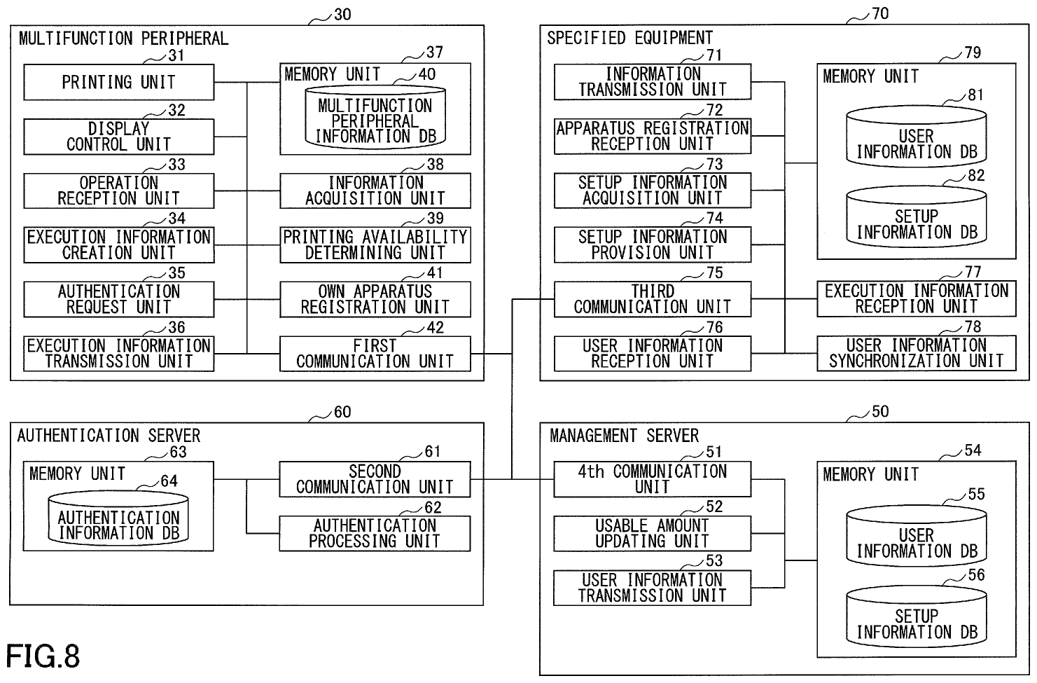

Next, the function of the user information administration system 100 will be described with reference to FIG. 8. FIG. 8 is an example of a functional block diagram illustrating functions of the multifunction peripheral 30, the authentication server 60, the specified equipment 70, and the management server 50 of a user information administration system 100 using blocks.

### <MFP>

The multifunction peripheral 30 includes a printing unit 31, a display control unit 32, an operation reception unit 33, an execution information creation unit 34, an authentication request unit 35, an execution information transmission unit 36, an information acquisition unit 38, a printing availability determining unit 39, an own apparatus registration unit 41, and a first communication unit 42. Each of these functions of the multifunction peripheral 30 is a function or means substantialized by CPU 311 executing the program 315p developed from the HDD 315 to the RAM 312 illustrated in FIG. 7. The program 315p may be distributed from a program delivery server or may be distributed in a state stored in a portable memory medium such as a USB memory or an optical memory medium.

The multifunction peripheral 30 includes a memory unit 37 substantialized by an HDD 315, a ROM 313, a RAM 312, or the like illustrated in FIG. 7. A multifunction peripheral information DB40 is constructed in the memory unit 37. Multifunction peripheral information DB40 will be described using Table 1.

TABLE 1
MULTIFUNCTION PERIPHERAL INFORMATION

| | |
|---|---|
| IP ADDRESS OF | 192.168.1.1 |
| MULTIFUNCTION | |
| PERIPHERAL | |
| URL FOR RECEIVING SETUP | http://www.sample.co.jp/ |
| CHANGE REPORT | |

Table 1 shows the multifunction peripheral information stored in the multifunction peripheral information DB40. The multifunction peripheral information DB 40 stores the IP address of the multifunction peripheral 30 and the URL for receiving a setup change report (the URL of the destination to which the specified equipment 70 sends the setup change report). The URL to receive the setup change report is address information of the destination to which the setup change report is sent. The setup change report is a notification that the specified equipment 70 transmits to the multifunction peripheral 30 in the event of any change in the setup information. Configuration information itself may be included.

Referring back to FIG. 8, an explanation will be given. The printing unit 31 renders the print data described by the printer driver in a PDL (Page Description Language) into image data and prints it on paper by an electrophotographic method, an ink jet method, or the like. The printer driver may operate on the client terminal 10, or in the case of secure printing (pull print printing), on the management server 50 acting on behalf of the printing server. Alternatively, the image data may be one for which the original document is scanned.

The display control unit 32 converts various information into a GUI (Graphical User Interface) or a CUI (Character User Interface) and displays the operation panel 302. In the present embodiment, a screen for accepting setup conditions of printing and copying is displayed.

The operation reception unit 33 receives various operations from the multifunction peripheral 30. As described above, the setting conditions for printing and copying are accepted and the start button for the job is clicked. The operation entry is performed by detecting the touch panel (when the operation panel 302 is a touch panel) or the hard key is pressed.

The execution information creation unit 34 creates the execution information indicating the execution contents of the job executed by the printing unit 31. For example, the number of pages, the number of copies, the black-and-white color, the single-sided and double-sided, and the paper size are recorded. The user ID of the logged-in user is also recorded so that it can be later checked which user performed it.

The authentication request unit 35 designates the user ID and password inputted by the user and transmits the authentication request to the authentication server 60 through the first communication unit 42. The authentication server 60 acquires the authentication result of the successful or unsuccessful authentication and the information of the user administered by the authentication server 60 (Table 2 to be described later).

The execution information transmission unit 36 transmits the execution information created by the execution information creating unit 34 to the specified equipment 70 through the first communication unit 42. The IP address and port number of the specified equipment 70 are preset by the administrator. Execution information may be sent for each completion of a job or for each completion of a given number of jobs. Alternatively, it may be transmitted at a fixed time, or it may be transmitted when the load of the multifunction peripheral 30 is low.

The information acquisition unit 38 acquires the setup information (information such as the IP address of the authentication server 60) and the user information from the specified equipment 70 through the first communication unit 42. The setup information and the user information are primarily administered by the management server 50, but the specified equipment 70 synchronizes the management server 50 with the user information.

The printing availability determining unit 39 determines whether the printing can be performed based on the user information acquired by the information acquisition unit 38. User information includes information on the remaining usable amount and information on functional use restrictions. It is determine whether a job set by the user can be executed without exceeding the remaining usable amount if it is permitted in the function usage limiting information.

The own apparatus registration unit 41 registers the multifunction peripheral information registered in the multifunction peripheral information DB40 in the management server 50 when the multifunction peripheral 30 starts up. As illustrated in Table 1, for example, the IP address of the multifunction peripheral 30 and the URL for receiving the setup change report (the URL of the destination to which the specified equipment 70 sends the setup change report) are set.

The first communication unit 42 transmits and receives various information between the authentication server 60 and the specified equipment 70. An authentication request is transmitted to the authentication server 60 and the authentication result is received. The execution information and the multifunction peripheral information are transmitted to the specified equipment 70, and the setup information and user information are received.

### <<Authentication Server>>

The authentication server 60 includes a second communication unit 61 and an authentication processing unit 62. Each of these functions provided by the authentication server 60 is a function or means substantialized by the CPU 206 executing the program 208p deployed from the HDD 208 to the RAM 204 illustrated in FIG. 6. The program 208p may be distributed from a program delivery server or may be distributed in a state stored in a portable storage medium such as a USE memory or an optical storage medium.

The authentication server 60 includes a memory unit 63 substantialized by the HDD 208, the ROM 205, the RAM 204, or the like illustrated in FIG. 6. The authentication information DB64 is constructed in the memory unit 63. First, the authentication information DB64 will be described using Table 2.

TABLE 2
AUTHENTICATION INFORMATION

| | | USER | | | | |
|---|---|---|---|---|---|---|
| USER | PASS- | DISPLAY | MAIL | FAX | | COST |
| ID | WORD | NAME | ADDRESS | NUMBER | DEPARTMENT | CENTER |
| suzuki | **** | SUZUKI | suzuki@ | 03-xxxx-xxxx | DEVELOPMENT | DEVELOPMENT |
| | | | sample.com | | CENTER | CENTER |

Table 2 shows an example of the authentication information stored in the authentication information DB64. The authentication information includes items such as a user ID, password, user display name, mail address, fax number, department, and cost center. The user ID is identification information to specify or identify the user.

In Table 2, the user ID is the user name, but if there is any uniqueness, the number or the alphabet may be used in combination. The password is information that confirms the user ID as described above. The user display name is used when the user who has logged in is displayed on the operation panel, etc. (the user's name, etc.). The e-mail address is an e-mail address for sending an e-mail to a user, such as the multifunction peripheral 30 or specified equipment 70. The fax number is the fax number used by the multifunction peripheral 30 or the specified equipment 70 to transmit the fax to the user. The department is information about the department to which the user belongs. The cost center is the information to be billed by the user according to the use of the multifunction peripheral 30.

Referring back to FIG. 8, an explanation will be given. The second communication unit 61 receives the authentication request including the user ID and password from the multifunction peripheral 30. The authentication result of the authentication processing unit 62 and a part or the whole of the authentication information in Table 2 are transmitted to the multifunction peripheral 30.

The authentication processing unit 62 generates the authentication result of the success or failure of authentication based on whether the user ID and password transmitted from the multifunction peripheral 30 are stored in the authentication information DB64.

### <Specified Equipment>

The specified equipment 70 includes an information transmission unit 71, an apparatus registration reception unit 72, a setup information acquisition unit 73, a setup information provision unit 74, a third communication unit 75, a user information reception unit 76, an execution information reception unit 77, and a user information synchronization unit 78. Each of these functions of the specified equipment 70 is a function or means substantialized by CPU 311 executing the program 315p expanded from the HDD 315 to the RAM 312 illustrated in FIG. 7. The program 315p may be distributed from a program delivery server or may be distributed in a state stored in a portable storage medium such as a USB memory or an optical storage medium.

The specified equipment 70 includes a memory unit 79 implemented by an HDD 315, a ROM 313, a RAM 312, or the like illustrated in FIG. 7. The user information DB81 and the setup information DB82 are constructed in the memory unit 79. The user information DB81 will be described using Table 3.

TABLE 3
USER INFORMATION

| | | | | | | | | FUNCTION |
|---|---|---|---|---|---|---|---|---|
| | USER | | | | | | REMAINING | USAGE |
| USER | DISPLAY | MAIL | FAX | | COST | USER | USABLE | LIMITING |
| ID | NAME | ADDRESS | NUMBER | DEPARTMENT | CENTER | GROUP | AMOUNT | INFORMATION |
| suzuki | SUZUKI | suzuki@ | 03-xxxx- | DEVELOPMENT | DEVELOPMENT | GROUP | 100/200 | COPYING AVAILABLE |
| | | sample.com | xxxx | CENTER | CENTER | 1 | | PRINTING AVAILABLE |
| | | | | | | | | SCANNING AVAILABLE |

Table 3 is an example of the user information stored in the user information DB81. Each item includes a user name, user display name, mail address, fax number, department, cost center, user group, remaining usable amount, and restricted use information. In order to share information with the authentication information DB64, it is the same as the authentication information DB64 except for the remaining usable amount and function usage limiting information. As a minimum, if only the user ID is shared, the specified equipment 70 can obtain any information from the authentication information DB64.

The remaining usable amount used is the number of pages a user can print over a time period. For example, “100/200” indicates that a total of 200 pages can be printed over a time period, while the rest is 100 pages. The function usage limiting information is the function of the multifunction peripheral 30 that is permitted to the user. In Table 3, copying, printing, and scanning are enabled or disabled. However, color printing and faxing may be enabled or disabled.

TABLE 4
SETUP INFORMATION

| IP ADDRESS OF | | |
|---|---|---|
| AUTHENTICATION | | TYPE OF IC |
| SERVER | JOB ERASING/SAVING | CARD READER |
| 192.168.1.2 | ERASING | R001 |

Table 4 is an example of the setup information stored in the setup information DB82. The setup information is various types of information set by the multifunction peripheral 30. For example, the IP address, job deletion/storage, and IC card reader type items of the authentication server 60 are registered. The IP address of the authentication server 60 is the IP address of the authentication server 60 to which the multifunction peripheral 30 requests the authentication. Job erasing/saving is a setting in which the management server 50 erases or saves the job after executing secure printing (pull print printing). The model of the IC card reader is the model number of the IC card reader in which the multifunction peripheral 30 is allowed to read the information on the IC card at the time of authentication by the user (to improve security).

The setup information DB82 may contain the common setup information of the multifunction peripheral 30 under the specified equipment 70, or the individual setup information of the multifunction peripheral 30 under the specified equipment 70 may be stored in association with the multifunction peripheral 30.

Referring back to FIG. 8, an explanation will be given. The execution information reception unit 77 receives execution information from the multifunction peripheral 30 through a third communication unit 75. Since the execution information is transmitted at the time when the multifunction peripheral 30 executes the job, it is not necessary to request it from the specified equipment 70. However, the multifunction peripheral 30 may transmit the execution information in response to an inquiry from the specified equipment 70.

The apparatus registration reception unit 72 receives the registration of the multifunction peripheral information through the third communication unit 75, such as when the multifunction peripheral 30 starts up. Said differently, the parent of which multifunction peripheral 30 is the specified equipment 70 is registered. The multifunction peripheral information is stored in the memory unit 79.

The timing of transmission is a state in which a certain amount or more of execution information transmitted from each multifunction peripheral 30 is accumulated, or a time in which execution information is accumulated for a certain period or more. The execution information that exceeds a certain amount includes, for example, 10 jobs and 1 Mbyte of execution information. The execution information for a certain time period or longer refers to implementation information for a certain time period, for example, once an hour or once a day.

TABLE 5
EXECUTION INFORMATION

| NUMBER | BLACK-AND- | | | DE- | | |
|---|---|---|---|---|---|---|
| OF | WHITE/ | SINGLE-SIDED/ | PAPER | PART- | COST | USER |
| PAGES | COLOR | DOUBLE-SIDED | SIZE | MENT | CENTER | ID |
| 10 | COLOR | SINGLE-SIDED | A4 | DEVELOPMENT | DEVELOPMENT | suzuki |
| | | | | CENTER | CENTER | |

Table 5 shows an example of execution information. The execution information may include, for example, the number of pages, black-and-white color, single-sided and double-sided, paper size, department, cost center, user ID, etc. These allow the user to know what job is performed and so as to charge.

Referring back to FIG. 8, an explanation will be given. The setup information acquisition unit 73 requests the setup information from the management server 50 through the third communication unit 75 and acquires the setup information through the third communication unit 75. Since the frequency of changing the setup information is not so high, the timing for acquiring the setting can be a regular timing, such as once a day. As described above, the setup information is the IP address or the like of the authentication server 60.

The setup information provision unit 74 transmits the setup information to the multifunction peripheral 30 in response to a request from the multifunction peripheral 30 through the third communication unit 75. When the setup information is changed, the URL that receives the setup change report of the multifunction peripheral 30 is notified. This allows the multifunction peripheral 30 to request the specified equipment 70 with the setup information accordingly. Alternatively, the setup information may be sent to the URL that receives a setup change report.

The user information reception unit 76 receives the user information from the management server 50 through the third communication unit 75. When the information transmission unit 71 transmits the execution information to the management server 50, the management server 50 updates the remaining usable amount of the user information with the execution information. The user information reception unit 76 receives at least the updated remaining usable amount from the management server 50. The entire user information may be received.

The user information synchronization unit 78 synchronizes the user information of the management server 50 with the user information of the specified equipment 70 by storing (overwriting) the user information received by the user information reception unit 76 in the user information DB81. Further, when the user information synchronization unit 78 receives the execution information from the multifunction peripheral 30, the user information synchronization unit 78 also updates the remaining usable amount. Accordingly, even if the user uses the multifunction peripheral 30 more than once by the timing when the specified equipment 70 transmits the execution information to the management server 50, the latest remaining usable amount can be maintained.

### <<Administration Server>>

The management server 50 includes a fourth communication unit 51, a usable amount updating unit 52, and a user information transmission unit 53. Each of these functions of the management server 50 is a function or a means substantialized by CPU 206 executing the program 208p deployed from the HDD 208 to the RAM 204 illustrated in FIG. 6. The program 208p may be distributed from a program delivery server or may be distributed in a state stored in a portable storage medium such as a USB memory or an optical storage medium.

The management server 50 includes a memory unit 54 implemented by the HDD 208, the ROM 205, the RAM 204, or the like illustrated in FIG. 6. A user information DB55 and a setup information DB56 are constructed in the memory unit 54. The user information DB55 and the setup information DB56 of the management server 50 may be the same as those of the specified equipment 70. This is because the user information DB55 and the setup information DB of the management server 50 are transmitted to the specified equipment 70 and synchronized.

The fourth communication unit 51 transmits and receives various information with the specified equipment 70. For example, the execution information is received from the specified equipment 70 and the setup information and user information are transmitted to the specified equipment 70.

The usable amount updating unit 52 updates the remaining usable amount of the user information DB55 based on the execution information received by the fourth communication unit 51. For example, if the number of pages of the execution information is 10 pages and the remaining usable amount is 100 pages, the remaining usable amount is updated to 100−10=90 pages.

The user information transmission unit 53 transmits the updated user information to the specified equipment 70 through the fourth communication unit 51. This allows the specified equipment 70 and the management server 50 to synchronize the user information.

### <Operation Procedure>

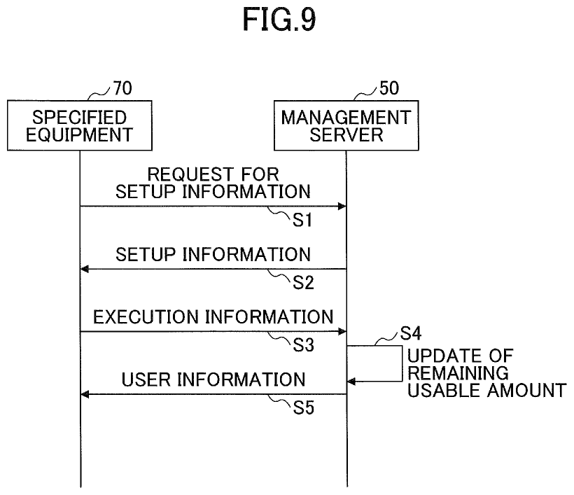

Next, a process of acquiring the setup information from the management server 50 by the specified equipment 70 will be described with reference to FIG. 9. FIG. 9 is a sequence diagram illustrating an example of a procedure in which the specified equipment 70 synchronizes the user information and the setup information with the management server 50.

S1: The setup information acquisition unit 73 of the specified equipment 70 requests the management server 50 to set information at a predetermined timing. The fourth communication unit 51 of the management server 50 receives the request of the setup information.

S2: The fourth communication unit 51 of the management server 50 acquires the setup information of the setup information DB56 and transmits it to the specified equipment 70. The setup information acquisition unit 73 of the specified equipment 70 acquires the setup information through the third communication unit 75 and updates the setup information DB82.

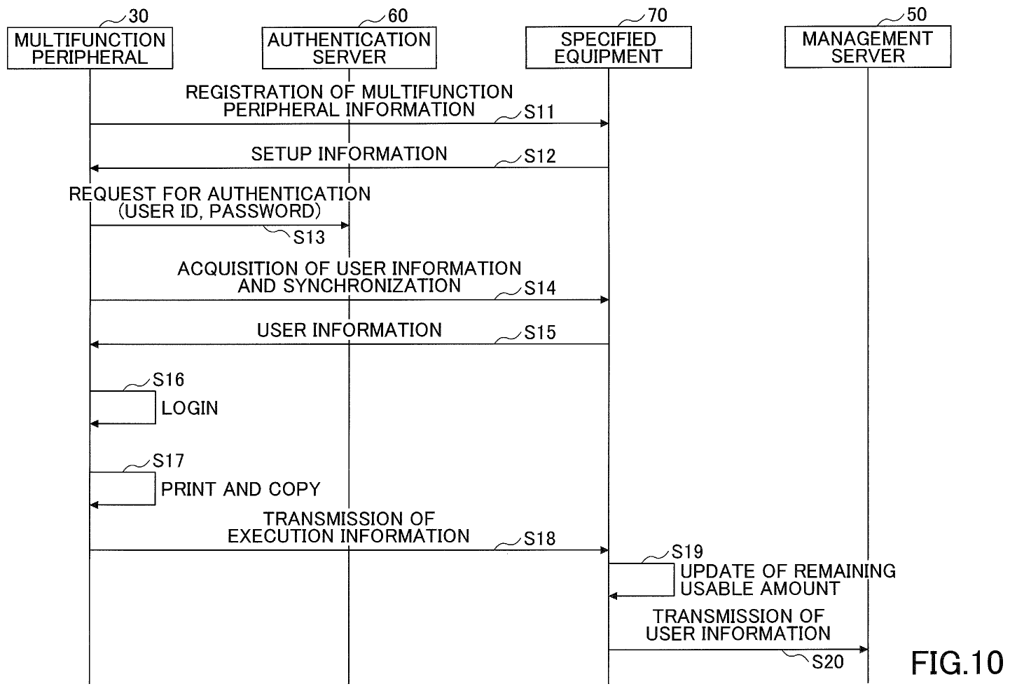

S3: As illustrated in FIG. 10, since the specified equipment 70 receives execution information from each of the multifunction peripherals 30, the information transmission unit 71 of the specified equipment 70 accumulates execution information in a certain amount or more or execution information for a predetermined time period or more and collectively transmits them to the management server 50. The execution information can be collectively sent if the execution information is not for the predetermined time period or the predetermined amount.

S4: The fourth communication unit 51 of the management server 50 receives the execution information, and the usable amount updating unit 52 calculates the remaining usable amount after updating based on the execution information and the remaining usable amount for the user information DB55 before updating. The usable amount updating unit 52 updates the remaining usable amount of the user information DB55 with the calculated remaining usable amount.

S5: The fourth communication unit 51 of the management server 50 transmits the updated user information to the specified equipment 70. The user information to be transmitted may be either the whole or the updated one.

As a result of the above process, the specified equipment 70 can synchronize the setup information DB82 and the user information DB81 with the setup information DB56 and the user information DB55 of the management server 50.

Next, a transmission process of the execution information when the user uses the multifunction peripheral 30 will be described with reference to FIG. 10. FIG. 10 is a sequence diagram illustrating authentication and transmission process of execution information when the user uses the multifunction peripheral 30.

S11: When the multifunction peripheral 30 starts up, the own apparatus registration unit 41 communicates with the management server 50 through the first communication unit 42 and registers its own multifunction peripheral information stored in the multifunction peripheral information DB40 in the management server 50. The apparatus registration reception unit 72 of the specified equipment 70 receives the multifunction peripheral information through the third communication unit and stores it in the memory unit 79. This allows the change in the setup information to be reported to the multifunction peripheral 30.

S12: When the multifunction peripheral 30 starts, the information acquisition unit 38 of the multifunction peripheral 30 acquires the setup information from the specified equipment 70. The setup information provision unit 74 of the specified equipment 70 receives the request for the setup information through the third communication unit and transmits the setup information of the setup information DB82 to the multifunction peripheral 30. This synchronizes the setup information between the multifunction peripheral 30 and the specified equipment 70.

S13: When the user uses the multifunction peripheral 30, the user inputs the user ID and password into the multifunction peripheral 30. The operation reception unit 33 of the multifunction peripheral 30 receives the user ID and password, and the authentication request unit 35 transmits the user ID and password to the authentication server 60 to request the user authentication. The authentication server 60 performs user authentication. In this embodiment, the authentication is successful. This identifies at least the user ID. If authentication fails, the multifunction peripheral 30 does not perform the subsequent processing. Therefore, even if the management server 50 does not perform authentication on its behalf, the security does not deteriorate.

S14: When the authentication request unit 35 acquires the information indicating that authentication is successful from the authentication server 60, the information acquisition unit 38 of the multifunction peripheral 30 communicates with the specified equipment 70 through the first communication unit 42 and acquires the user information specifying the user ID. For example, the purpose is to determine whether to print based on the remaining usable amount and function usage limit. In addition, the mail address etc. may be obtained.

S15: The third communication unit 75 of the specified equipment 70 transmits the user information to the multifunction peripheral 30 that authenticated the user. This synchronizes the user information between the multifunction peripheral 30 and the specified equipment 70.

S16: Successful authentication allows the user to log into the multifunction peripheral 30. The user sets the print settings such as color/monochrome, paper size and the like to the multifunction peripheral 30. The operation reception unit 33 receives the print setting.

S17: The printing availability determining unit 39 determines whether a job is permitted under the function usage limit determines whether the number of pages of the print setting exceeds the remaining usable amount, and determines that a job can be executed when the number of pages of the print setting is permitted under the function use limit and the remaining usable amount is not exceeded. In this case, the user can perform printing, copying, and the like. The printing unit 31 performs the printing, and the execution information creation unit 34 produces the execution information. When it is determined that the printing availability determining unit 39 cannot execute the job, an error message is displayed on the operation panel 302 and the job is not executed.

S18: The execution information transmission unit 36 of the multifunction peripheral 30 transmits the execution information to the management server 50 through the first communication unit 42. Execution information contains a user ID to identify the user.

S19: The execution information reception unit 77 of the specified equipment 70 receives the execution information through the third communication unit 75, and the user information synchronization unit 78 updates the remaining usable amount. Next time, when the user requests authentication as in step S13, the user information including the remaining usable amount updated by the specified equipment 70 is transmitted to the multifunction peripheral 30.

In the case of the specified equipment 70 and the multifunction peripheral 30, the specified equipment 70 also prepares the execution information. This execution information is retained by the specified equipment 70 and transmitted to the specified equipment 70 together with the execution information transmitted from the multifunction peripheral 30.

S20: The information transmission unit 71 of the specified equipment 70 accumulates the execution information to be more than the predetermined amount or more than the predetermined time period and collectively transmits the execution information to the management server 50. The subsequent processes may be the same as step S4 and step S5 of FIG. 9.

As described above, since the specified equipment 70 collectively transmits the execution information to the management server 50, the increase in the communication load can be suppressed. As a supplement, for example, when communicating over HTTP, the HTTP header is required for each transmission, so that the more the transmission is divided into multiple, the greater the communication load, even if the total amount of data is the same. In the present embodiment, the communication load can be reduced because the number of communication times is reduced by transmitting multiple execution information together.

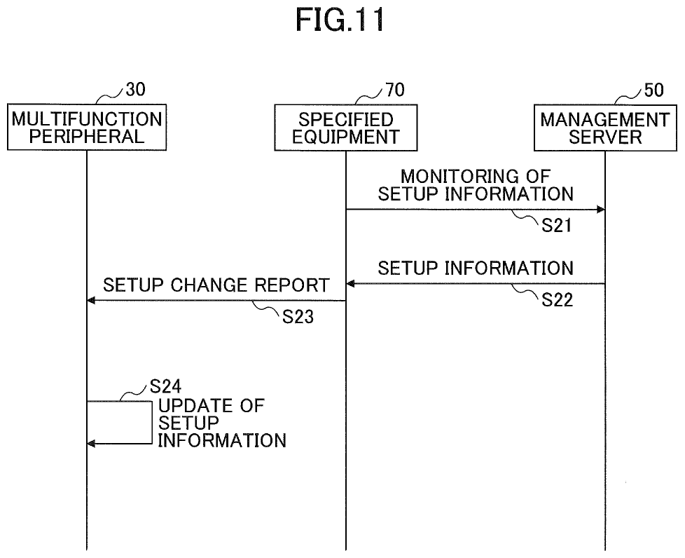

Next, the updating of the setup information of the multifunction peripheral 30 when the setup information is changed will be described with reference to FIG. 11.

FIG. 11 is a sequence diagram illustrating the process of updating the setup information of the multifunction peripheral 30 when the setup information is changed.

S21: The administrator or the like can change the setup information of the management server 50 in a suitable manner.

The setup information acquisition unit 73 of the specified equipment 70 regularly communicates with the management server 50 to monitor the change of the setup information.
For example, when the setup information acquisition unit 73 inquires about the change of the setup information and there is a change, the setup information acquisition unit 73 receives an issue that the change has been made.

S22: When the setup information is changed, the setup information acquisition unit 73 of the specified equipment 70 acquires the changed setup information from the management server 50 through the third communication unit 75.

S23: The setup information provision unit 74 of the specified equipment 70 notifies the URL receiving the setup change report of the setting change of the setup information. Thus, the multifunction peripheral 30 may request the setup information of the specified equipment 70, or the specified equipment 70 may transmit the setup information to the multifunction peripheral 30 together with the setup change report.

S24: The information acquisition unit 38 of the multifunction peripheral 30 receives the setup information through the first communication unit 42 and reflects the setup information on itself.

Accordingly, even if the management server 50 is present in the cloud, the specified equipment 70 can detect a change in the setup information and reflect the change in the setup information on the multifunction peripheral 30.

### SUMMARY

As described above, in the user information administration system 100 according to the present embodiment, the management server 50 is on the cloud side and the authentication server 60 is on the on-premise side. However, since the multifunction peripheral 30 communicates with the authentication server 60, user authentication is possible. In addition, since the specified equipment 70 transmits the execution information transmitted from at least one multifunction peripheral 30 to the management server 50, the communication load of the management server 50 and the network can be reduced compared to the case where each multifunction peripheral 30 communicates with the management server 50 individually.

### Other Applications

While the preferred embodiment of the present invention has been described with reference to examples, various modifications and substitutions may be made thereto without departing from the spirit and scope of the invention.

For example, a configuration example such as that illustrated in FIG. 8 is divided according to the main functions in order to facilitate understanding of the processes by the multifunction peripheral 30, the authentication server 60, the specified equipment 70, and the management server 50. The embodiment of the present application is not limited by the method of dividing the processing unit or by the name. The processes of the multifunction peripheral 30, the authentication server 60, the specified equipment 70, and the management server 50 may be divided into more processing units depending on the processing contents.

Alternatively, one processing unit can be split to include more processes. Each database need not be located within each apparatus, but only in a network accessible location.

The functions of the management server 50 may be distributed among a plurality of apparatuses to implement the functions of one management server 50, or there may be a plurality of management servers 50.

The functions of the embodiments described above may also be implemented by one or more processing circuitries. As used herein, a “processing circuitry” includes a processor programmed to perform each function by software, such as a processor implemented in electronic circuits, an ASIC (Application Specific Integrated Circuit) designed to perform each function as described above, a digital signal processor (DSP), a field programmable gate array (FPGA), or a conventional circuit module.

The execution information reception unit 77 is an example of the execution information reception unit, the information transmission unit 71 is an example of the execution information transmission unit, the user information synchronization unit 78 is an example of the user information synchronization unit, the third communication unit 75 is an example of the user information transmission unit, the setup information acquisition unit 73 is an example of the setup information acquisition unit, the setup information provision unit 74 is an example of the setup information transmission unit, and the apparatus registration reception unit 72 is an example of the setup registration reception unit. The printing unit 31 is an example of the execution unit, the execution information creation unit 34 is an example of the execution information producing unit, and the execution information transmission unit 36 is an example of the second execution information transmission unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the specified equipment has been described in detail, it should be understood that various changes, substitutions, and alterations could be made thereto without departing from the spirit and scope of the invention.

What is claimed is:

1. Specified equipment that communicates with a plurality of apparatuses to transmit execution information for executing a job of a user to an management server on a side of cloud, the specified equipment comprising:
a circuitry that performs
receiving the execution information of the job which is created by the plurality of apparatuses as a result of executing the job by the user who is successfully authenticated in an authentication server, and
transmitting the execution information received from the plurality of apparatuses to the management server every predetermined time period.

2. The specified equipment according to claim 1, the circuitry further performs
acquiring a remaining usable amount for the user of using the plurality of apparatuses from the management server storing the remaining usable amount and causing the acquired remaining usable amount to synchronize with the management server, and
transmitting the remaining usable amount for the user acquired from the management server to the apparatus authenticating the user by the authentication server.

3. The specified equipment according to claim 2,
wherein, in a case of the receiving the execution information of the job, which is created by the plurality of apparatuses as a result of executing the job by the user who is successfully authenticated in an authentication server, and
wherein the transmitting the remaining usable amount transmits the remaining usable amount for the user updated by the acquiring the remaining usable amount and causing the acquired remaining usable amount to synchronize with the management server to the apparatus authenticating the user by the authentication server.

4. The specified equipment according to claim 2,
wherein the acquiring the remaining usable amount and causing the acquired remaining usable amount to synchronize with the management server acquires function usage limiting information for the user of using the apparatus from the management server, and
wherein the transmitting the remaining usable amount transmits the remaining usable amount limiting information acquired from the management server to the apparatus authenticating the user by the authentication server.

5. The specified equipment according to claim 1,
wherein the specified equipment has a function for executing the job, and
wherein the transmitting the execution information transmits the execution information received from the plurality of apparatuses to the management server every predetermined amount or every predetermined time period, the transmitted execution information including the execution information generated by the specified equipment.

6. The specified equipment according to claim 1, the circuitry further performs
acquiring setup information related to setting of the plurality of apparatuses from the management server that stores the setup information, and
transmitting the setup information acquired by the acquiring to the plurality of apparatuses.

7. The specified equipment according to claim 6,
wherein the setup information is an IP address of the authentication server, setting of whether to delete or store a job after executing the job, or a type of an IC card reader used for the authentication.

8. The specified equipment according to claim 6, the circuitry further performs
receiving setting of address information used for the plurality of apparatuses to receive a setup change report of the setup information from the specified equipment from the plurality of apparatuses, wherein in a case where the receiving the setting of the address information receives a report indicating that the setup information is changed from the management server,
the receiving the setting of the address information transmits the setup change report to the address information.

9. A system comprising:
a plurality of apparatus; an management server on a cloud; and specified equipment that transmits execution information of a job for a user to the management server through a network,
wherein the specified equipment includes a circuitry that performs
receiving execution information of the job which is created by the plurality of apparatuses as a result of executing the job by the user who is successfully authenticated in the authentication server, and
transmitting the execution information received from the plurality of apparatuses to the management server every predetermined time period, wherein each of the plurality of apparatuses includes executing the job,
creating the execution information related to execution of the job by the executing the job, and
transmitting execution information created by the creating the execution information to the specified equipment.
